(19) United States
(12) Patent Application Publication
(10) Pub. No.: US 2018/0268310 A1
(43) Pub. Date: Sep. 20, 2018

(54) MULTI-INPUT ADAPTIVE DECISION MAKING ENGINE

(71) Applicant: OHI Technology, LLC., Silverthorne, CO (US)

(72) Inventors: Jonathan D. Kamins, Dillon, CO (US); Jared Fitch, South Jordan, UT (US); John Niels Petty, Draper, UT (US); Craig Hobson, Saratoga Springs, UT (US); Mitch Weight, Provo, UT (US); R. Parker Wightman, Herriman, UT (US)

(21) Appl. No.: 15/920,262

(22) Filed: Mar. 13, 2018

Related U.S. Application Data
(60) Provisional application No. 62/471,719, filed on Mar. 15, 2017.

(51) Int. Cl. G06N 5/04; G06F 17/30

(52) U.S. Cl. CPC G06N 5/045; G06F 17/3053; G06F 17/30554

(57) ABSTRACT

A computer system for managing a multi-input adaptive decision making engine generates a first query object that requests a decision input relating to a relationship between a first variable and a second variable. The system receives from a first decision engine, a relationship indication that characterizes a relationship between the first variable and the second variable. Responsive to receiving the relationship indication, the system stores a first relationship attribute within a first variable dataset. The system also stores a second relationship attribute within a second variable dataset. The system then stores a decision attribute within a first decision engine dataset.

### CROSS-REFERENCE TO RELATED APPLICATIONS

This application claims priority to and the benefit of U.S. Provisional Application No. 62/471,719, filed on Mar. 15, 2017, entitled “MULTI-INPUT ADAPTIVE DECISION MAKING ENGINE,” which is incorporated by reference herein in its entirety.

### BACKGROUND

Computers and computing systems have affected nearly every aspect of modern living. Computers are generally involved in work, recreation, healthcare, transportation, entertainment, household management, etc. Recent technology efforts and interest have focused on computer-based decision making. In many cases, computers are capable of making decisions much faster and much more accurately than a human.

Despite the significant benefits that are provided by computer-based decision making, there are several technical challenges to be overcome in the field. For example, many computer-based decision making systems rely upon a single algorithm to make decisions within the system. These systems have a single point of failure or error that is capable of polluting all decisions made by the system.

Additionally, decision making engines that rely upon multiple inputs may require significant memory and engine management overhead. For example, some decision making engines feed inquiries to multiple different engines, with some engines receiving the same inquiry. Each engine may provide unique, or even conflicting, answers. If any single engine or subset of the engines is provided with an inordinate portion of the questions, the unique outputs of those engines may cause the results provided by the entire system to drift.

In view of the above, there are several technical problems involved with managing computer-based decision making. Technical solutions to these problems will advance the technical art through more efficient management and control of information within a computer system.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include a computer system for managing a multi-input adaptive decision making engine. The computer system includes one or more processors and one or more computer-readable media having stored thereon executable instructions that when executed by the one or more processors configure the computer system to perform various actions. For example, the system generates a first query object that requests a relationship indication relating to a relationship between a first variable and a second variable. The first variable and the second variable are presented with the first query object. Additionally, the system receives from a first decision engine, the relationship indication that characterizes a relationship between the first variable and the second variable.

Responsive to receiving the relationship indication, the system stores a first relationship attribute within a first variable dataset. The first relationship attribute is based upon the relationship indication. The system also stores a second relationship attribute within a second variable dataset, wherein the second relationship attribute is based upon the decision input. The system then stores a decision attribute within a first decision engine dataset. The decision attribute indicates that the first decision engine has generated a relationship indication with respect to the first variable and the second variable.

In an additional or alternative embodiment, disclosed embodiments include a method for managing a multi-input adaptive decision making engine. The method includes selecting a first profile associated with a first user from a first dataset. The method also includes selecting a second profile associated with a second user from a second dataset.

The method additionally includes generating a first query object that requests a decision input relating to a relationship between data within the first profile and data within the second profile. The method also includes generating a user interface object that includes the first query object. The method further comprises identifying multiple profiles associated with multiple users from a third dataset.

The method includes then displaying the user interface object to the multiple users. The method also includes receiving relationship indications from the multiple users, wherein the relationship indications characterizes a relationship between the first user and the second user. The method further includes displaying to the first user a visual indication that corresponds to the relationship indications from the multiple users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a schematic diagram of an embodiment of a system for a multi-input decision making engine.

FIG. 2 illustrates an embodiment of a user interface within a multi-input decision-making engine.

FIG. 3 illustrates an embodiment of another user interface within a multi-input decision-making engine.

FIG. 4 illustrates an embodiment of another user interface within a multi-input decision-making engine.

FIG. 5 illustrates an embodiment of steps in a flow chart for a multi-input decision-making engine.

### DETAILED DESCRIPTION

Disclosed embodiments provide systems, methods, and apparatus for managing a multi-input adaptive decision making engine. In at least one embodiment, a multi-input adaptive decision making engine receives decision inputs from a variety of different sources. The received decisions may be cumulative with respect to the same question or may be diversely directed towards a plurality of different questions that share a common theme.

Additionally, disclosed embodiments manage the multiple decision inputs and calculated outputs in highly efficient structures that utilize less space than conventional storage means. Further, disclosed embodiments also manage the multiple decision inputs and calculated outputs in such a way as to increase processing and decrease the consumption of system resources that are conventionally incurred when handling multiple diverse inputs.

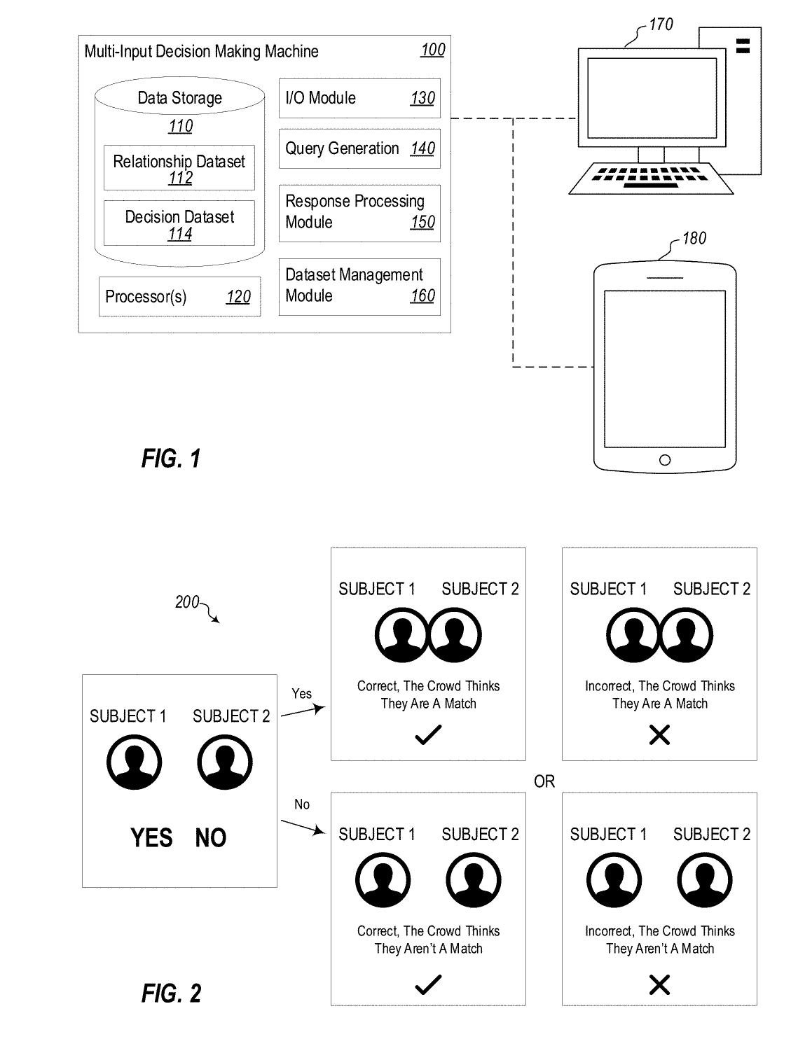

Turning now to the figures, FIG. 1 illustrates a schematic diagram of an embodiment of a system for a Multi-input decision making engine 100. In at least one embodiment, the Multi-input decision making engine 100 is executed within a computer system that comprises various modules and components. One will appreciate, however, that the modules and components depicted in FIG. 1 are provided only for the sake of example. In additional or alternative embodiments, the Multi-input decision making engine 100 may comprise more, fewer, or alternative modules and components and function equivalently.

The embodiment of the Multi-input decision making engine 100 depicted in FIG. 1 comprises a data storage 110, processor(s) 120, an I/O module 130, a Query Generation Module 140, a Response Processing Module 150, and a Dataset Management Module 160. The Multi-input decision making engine 100 is in communication with an exemplary personal computer 170 and/or an exemplary mobile device 180. The Multi-input decision making engine 100 is configured to send data to the personal computer 170 and/or mobile device 180 for display. The personal computer 170 and/or mobile device 180 communicate data back to the Multi-input decision making engine 100.

In at least one embodiment, the query generation module 140 generates a first query object that requests a relationship indication relating to a relationship between a first variable and a second variable. As used herein, a “query object” comprises a digital indication requesting input from a decision engine regarding the relationship between one or more variable.

The first variable and the second variable are presented within the first query object such that the first variable and the second variable are presented to one or more decision engines for processing. As used herein, a “variable” comprises a digital time presented to a decision engine. In at least one embodiment, the first variable and the second variable are gathered, at least in part, from an external data source. For example, the first variable may be associated with a user profile. The user profile may be stored, at least in part, on the user's mobile device 180. As such, in at least one embodiment, when generating the first query object, the query generation module 140 queries the mobile device 180 for a user profile. The query generation module 140 then generates a query object that comprises a first variable relating to the user profile. In at least one embodiment, the query object can similarly gather a user profile from a second mobile device (not shown) and generate a second variable within the query object.

Once presented with a query object, a decision engine provides a relationship indication for the first variable and second variable. The relationship indication may indicate that the first variable and the second variable are related, are not related, should be related, and/or are perceived as being well matched. In additional or alternative embodiments, the relationship indication may indicate relative relationship status between the two variables. For example, the relationship indicator may indicate that one variable is older, newer, bigger, smaller, faster, slower, better, worse, or any other relative indication. One will appreciate that these relationship indications are merely exemplary and that a wide number of additional or alternative indications can be used.

In at least one embodiment, the relationship indication may comprise a subjective indication of relatedness. For instance, the relationship indication may be subjective in that at least one decision engine may not be able to directly compute a quantitative analysis of relatedness. Instead, the decision engine may be required to rely upon analysis of correlated factors that do not necessarily indicate causation. For example, the two variables may be photos or videos of two different individuals and the relationship indication may comprise an indication that the two different individuals would be a good match for each other. As further examples, the relationship indicator may indicate which movie is better between two presented movies, which food is better between two presented foods, which travel route is faster between two presented routes, or any other similar request for a subjective relationship indicator.

In at least one embodiment, the one or more decision engines comprise user interface inputs that are received from human users. For instance, the multi-input decision-making engine 100 may receive from a first decision engine a relationship indication that characterizes a perceived relationship between the first variable and the second variable. The first decision engine may comprise input received from mobile device 180. The relationship indication may comprise an indication as to whether an individual represented by the first variable would be a good relationship match with an individual represented by the second variable.

In additional or alternate embodiments, the one or more decision engines comprise one or more of other human users providing their input, neural networks, mathematical algorithms, random noise generators, and any other system capable of generating a relationship indication. For example, at least one decision engine may comprise a vision algorithm that generates a relationship indication based upon a cross reference of specific attributes associated with the first variable and the second variable.

Upon receiving the relationship indication, the response processing module 150 stores a first relationship attribute within a first variable dataset and a second relationship attribute within a second variable dataset. The respective relationship attributes are based upon the relationship indications received from the decision engines. For example, the relationship attributes may indicate that a decision engine views the two first variable and the second variable as a good relationship match. In at least one embodiment, the first relationship attribute is the same as the second relationship attribute.

In the depicted embodiment, the first variable dataset and the second variable dataset are stored within the relationship dataset 112. As such, the relationship dataset 112 contains information about the perceived relationship compatibility between the first variable and the second variable. In at least one embodiment, the first variable may be associated with a particular user account. In such a case, the first variable dataset may be stored on an end-user device that is associated with the user. As such, the first variable dataset is stored with a device that is associated with the first variable. In at least one embodiment, distributing the storage of the first variable dataset in this way decreases localized storage needs, increases data security, and also allows the user to move between different decision engines that can rely, in part, on the first variable dataset.

As described herein, multiple different user inputs for multiple different users can be used as decision engines, and multiple different variables can be presented as potential matches to the one or more decision engines. Overtime, a consensus relationship indication can be calculated based upon a weighted summation of relationship attributes received from multiple different decision engines. In at least one embodiment, each decision engine is associated with a weighting factor. The consensus relationship indication is calculated by summing all of the relationship indications received from any decision engine with respect to a particular relationship between a first variable and a second variable. Each received relationship indication is weighted by the weight associated with its respective decision engine. The consensus relationship indication is determined to be whatever relationship characterization comprises the highest weighted score.

Once a consensus relationship indication is determined, the weightings associated with each decision engine that agreed with the consensus relationship indication may be increased. In this way, over time decisions engines that more closely align with consensus are given more weighting in decisions. In contrast, in at least one embodiment, the weightings associated with each decision engine that disagreed with the consensus relationship indication may be decreased. In this way, over time decisions engines that do not align with consensus are given less weighting in decisions.

Additionally, in at least one embodiment, the dataset management module 160 manages and tracks interactions between the decision engines and the variables. For example, the dataset management module 160 stores a decision attribute within a first decision engine data set. The decision attribute indicates that the first decision engine has generated a relationship indication with respect to the first variable and the second variable. As depicted in FIG. 1, the first decision engine dataset is stored within the decision dataset 114.

In various embodiments, the multi-input decision-making engine 100 tracks both the inputs received with respect to relationships between different variables and which decision engines have provided responses with respect to specific pairs of variables. Tracking the inputs received from the various decision engines and the specific pairs of variables that have been presented to the respective engines can increase the accuracy and speed at which the multi-input decision-making engine 100 operates. For example, in at least one embodiment, the decision engines may comprise a mixture of computer-based decision engines and decision engines based upon input received from users. If the same combination of variables is presented to the same decision engine substantially more times than that combination is presented to any other engines, the resulting relationship indication may be improperly skewed by the particular analysis of that decision engine. To avoid this problem, the dataset management module 160 tracks the interactions between the decision engines and the various variables and ensures that variables pairs are properly distributed between the different decision engines.

In at least one embodiment, each decision engine dataset is physically stored with the respective decision engine. For example, a decision engine may comprise a user on mobile device 180. A dataset management module 160 installed on the mobile device 180 manages and tracks the different variables that are presented to the user in query objects. The dataset management module 160 generates decision attributes that indicate the pairs of variables that have been presented to the user.

Under such a system, significant processing and network gains can be realized. For example, to avoid presenting the same decision engine with the same pairs of variables multiple times, a query generation module 140 must access the decision engine data set for each decision engine every time a query object is created. Performing this within a centralized location and then pushing out query objects to individual decisions engines could incur significant overhead costs—especially with large datasets.

In at least one embodiment, the bottleneck created by the overhead of centrally processing each data query can be avoided by off-loading the processing to the decision engines themselves. For example, the multi-input decision making engine 100 could detect a network connection from the decision engine associated with mobile device 180. In response to detecting the network connection, the query generation module 140 pushes out to the mobile device 180 a random selection of a set of variables. The number of variables within the random set may be determined based upon the frequency with which the mobile device 180 connects to the multi-input decision making engine 100, where a larger set is sent if the connections are infrequent. Additionally or alternatively, the number of variables in the set may be determined by other means.

Once the mobile device 180 receives the set of variables from the query generation module 140, the mobile device 180 stores the variables locally. When a request from the decision engine (i.e., the user) is made for a query object, a query generation module executing on the mobile device 180 then checks individual pairings of variables against the decision engine dataset that is stored locally on the mobile device 180. If the query generation module identifies that a particular paring has previously been presented to the decision engine, the query generation module discards the pairing and generates a new one.

Accordingly, in at least one embodiment, at least a portion of the query objects are generated locally at the decision engine. As discussed above, such a configuration can prevent bottlenecks from occurring at a centralized server that manages all data queries. Additionally, in at least one embodiment, mobile device 180 is able to function even when there is no network connection with the multi-input decision making engine 100 because it can continue to iterate through variable pairings within the set of variables. When a connection is again made to the multi-input decision making engine 100, the mobile device 100 can upload to the multi-input decision making engine 100 any decision indications that were generated. Additionally, the mobile device 100 can synchronize its decision engine dataset the decision engine dataset 114 stored at the multi-input decision making engine 100.

In various embodiments, the multi-input decision-making engine is deployed via a smartphone application or web application that enables a crowd of many individuals to make decisions and recommendations for other users. The multi-input decision-making engine 100 may take the form of a crowd-based decision making engine (CBDME). This engine utilizes the expertise of users to determine which participants, items, concepts or forecasts are a match. The engine works by asking users to select whether one of the options displayed is perceived as the most popular. When they guess the correct answer, they are awarded points. The result is that the crowd (collective result of disparate users polled) determines which matches are most popular and thus most likely to succeed together. This innovation is unique in multiple ways, including that rather than using traditional polling, the device uses social signals to establish whether a match is found or not.

In at least one embodiment, because the multi-input decision-making engine 100 leverages crowd-based inputs to identify which options are the most popular, users of the engine will be able to invite friends, family and others to work in their behalf. For instance, at least one embodiment may take the form of a dating application that allows a user to share their profile with friends and family and ask them to use the multi-input decision-making engine 100 to find a dating match for the user.

The query generation module 140 will serve up various potential suitors and the crowd will determine which suitors are a match, and which are not. The end result is that the user will receive a list of potential suitors ranked by popularity and be given the opportunity to communicate with those users.

FIG. 2 illustrates an embodiment of a query object 200 within a multi-input decision-making engine 100. As depicted, a user is shown a first picture and a second picture, also referred to herein as a first variable and a second variable. The user is then asked to provide a relationship indication by selecting “yes” or “no.” Upon providing an input, the user is then shown whether their input matches with the aggregation of other inputs or deviates from it. For example, the first column of figures indicates that the user's answer matches the aggregation of the other inputs. In contrast, the second column of figures indicates that the user's input deviates from the aggregation of other inputs.

In at least one embodiment, a user can also invite complete strangers to use the multi-input decision-making engine 100 for them. Again, using a dating application as an example, the user submits her profile to the application and makes it available for matching. Complete strangers will compare the user's profile with profiles of potential suitors and determine which suitors would be the best match for her based on perceived popularity.

In additional or alternative embodiments, the multi-input decision-making engine 100 includes the ability for users to initiate a matching opportunity. For example, users could select various sets to be judged by the multi-input decision-making engine 100 to discover the most popular outcome. Continuing with our dating application example, a user on the platform is reviewing a pair of potential matches. Upon determining that she would like to be introduced to one of the individuals being presented for matching, the user may request that the multi-input decision-making engine 100 insert that individual into her list of potential suitors. The multi-input decision-making engine 100 then displays the potential match to other users for review. If the crowd determines that they're a match, then the user is able to engage with the potential suitor. Additionally, in at least one embodiment, the multi-input decision-making engine 100 enables users to share potential matching candidates with family and friends or temporarily save a candidate to be inserted later, when a more appropriate match for that candidate is found.

While the present disclosure has provided a dating application as an example, one of skill in the art will appreciate that the disclosed multi-input decision-making engine 100 can be used for advertising, business forecasting and decision making as well as a myriad of applications where multiple decision engines are able to provide better feedback. Further, one will understand that the decision engines may take the form of a mixture of user inputs and/or computer-based decision engines.

In at least one embodiment, to help ensure accurate variables are presented to the multi-input decision-making engine 100, the I/O module utilizes input measures that are harder to fake. Returning to the example of a dating application, user-generated content may be required to be fresh and accurate. For example, all representations of users may be generated on-platform via their device's camera. The system may prohibit the use of still photos of users and/or pre-captured content. Instead, users record themselves answering questions or completing other application-prompted videos so that others using the multi-input decision-making engine 100 can match them appropriately. For non-interpersonal connection applications, like ad testing and forecasting, users will be able to upload content specific to the application.

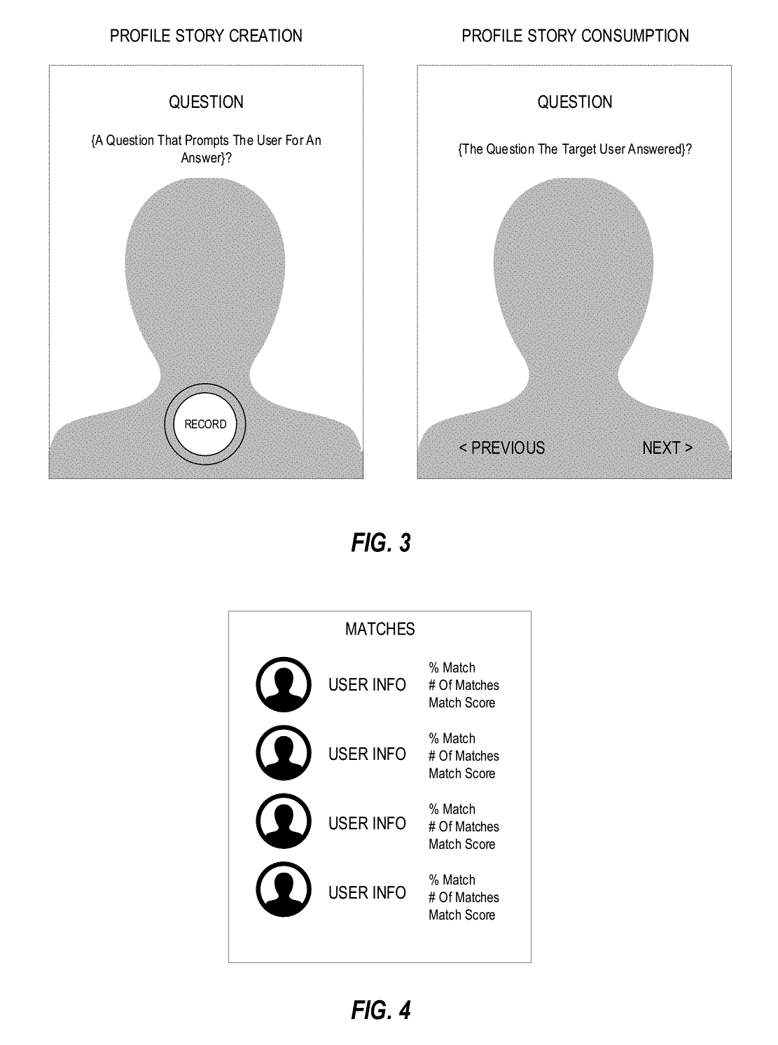

For example, FIG. 3 illustrates an embodiment of another user interface within a multi-input decision-making engine 100. In the first image, a first user is requested to record themselves answering a particular question. In the second image, a second user is able to see the question that the first user answered and view the video of the user answering the question.

In at least one embodiment, the multi-input decision-making engine 100 provides users with the ability to see the results as determined by the decision engines (e.g., the crowd). For example, each user will be able to see which matches the crowd determined were popular and the percentage or number of matches. This “social proof” helps users prioritize decisions based on what the crowd deems popular. In the case of interpersonal connection applications like dating, social networking or business networking, users will be able to confidently connect with prospects knowing that the crowd selected the match. As an example, in a dating application, this results screen shows which prospective suitors had the highest number of recommendations from the multi-input decision-making engine 100, and the user will then be able to contact those prospects they chose to engage with.

FIG. 4 illustrates an embodiment of another user interface within a multi-input decision-making engine 100. The depicted user interface provides a user with information about each person who was matched to them, the percentage of matches, the number of matches, and an overall match score. In at least one embodiment, the I/O module 130 gathers this information from the relationship dataset 112.

The multi-input decision-making engine 100 provides users with the opportunity to influence real-life results. For example, the multi-input decision-making engine 100 provides users with updates on the long-term impact of the decisions of individual users. For example, returning to the dating application example, users who have been matched by the multi-input decision-making engine 100 are able to post status updates on their relationship over time. Each user who correctly matched those users will receive a relationship status update. In other words, participants who matched a particular couple will receive updates when the couple goes on their first date, gets married, or reaches other important milestones.

Continuing with the exemplary dating application, in at least one embodiment, after an individual user accesses the results the multi-input decision-making engine 100 has produced, the user will have the ability to communicate with the person to whom they were matched. For example, the multi-input decision-making engine 100 may provide users with the ability to message each other via asynchronous video messages. As such, a user can record a video and send it to the other user for viewing at his or her convenience. Additionally, multi-input decision-making engine 100 may provide the users with prompts for recording videos. So, if a user is unsure of what to say or do in a video, the system will ask them questions that they can answer while recording—creating meaningful content for the recipient.

In at least one embodiment, the multi-input decision-making engine 100 also makes it easy for users to remain safe and anonymous. For example, users are able to select a username (rather than reveal any personal information) and communicate easily on-platform. To provide even more robust security, users are able to block or pause communications with another user. This way conversations can be terminated for any reason without the risk of spamming or stalking by the offending party. The pausing of communication can be performed indefinitely or over a period of time.

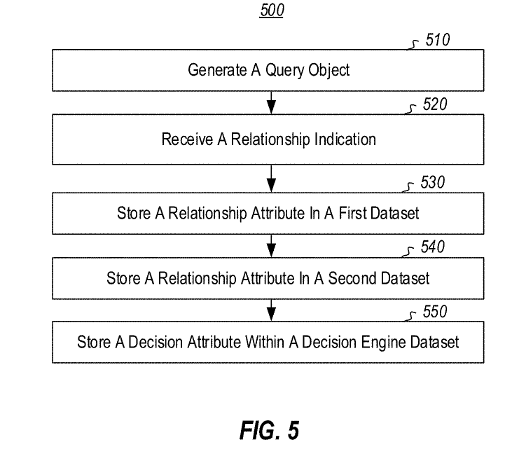

Accordingly, FIGS. 1-4 and the corresponding text illustrate or otherwise describe one or more components, modules, and/or mechanisms for managing a multi-input adaptive decision making engine. One will appreciate that implementations of the present invention can also be described in terms of methods comprising one or more acts for accomplishing a particular result. For example, FIG. 5 and the corresponding text illustrate or otherwise describe a sequence of acts in a method managing a multi-input adaptive decision making engine. The acts of FIG. 5 are described below with reference to the components and modules illustrated in FIGS. 1-4.

For example, FIG. 5 illustrates that a method 500 for managing a multi-input adaptive decision making engine includes an act 510 of generating a query object. Act 510 includes generating a first query object that requests a first relationship indication indicating a relationship between a first variable and a second variable. The first variable and the second variable are presented with the first query object. For example, as depicted and described with respect to FIGS. 2, a query object 200 is presented to a decision engine. In alternative embodiments, the query object 200 may not comprise a graphical user interface. For example, the query object 200 may simply comprise a digital communication requesting a response.

FIG. 5 also illustrates that method 500 includes an act 520 of receiving a relationship indication. Act 520 comprises receiving from a first decision engine, the first relationship indication that characterizes the relationship between the first variable and the second variable. For example, as depicted and described with respect to FIGS. 1 and 2, a decision engine can generate a relationship indication in response to the query object. The resulting relationship indication is received by the response processing module 150.

Additionally, FIG. 5 illustrates that the method 500 includes an act 530 of storing a relationship attribute in a first dataset. Act 530 comprises, responsive to receiving the first relationship indication, storing a first relationship attribute within a first variable dataset. The first relationship attribute is based upon the first relationship indication. For example, as depicted and described with respect to FIG. 1, the response processing module 150 stores the relationship attribute into a first variable dataset that is stored within the relationship dataset 112.

FIG. 5 further illustrates that the method 500 includes an act 540 of storing a relationship attribute in a second dataset. Act 540 comprises, responsive to receiving the first relationship indication, storing the first relationship attribute within a second variable dataset. The first relationship attribute is based upon the first decision input. For example, as depicted and described with respect to FIG. 1, the response processing module 150 stores the relationship attribute into a second variable dataset that is stored within the relationship dataset 112.

Further still, FIG. 5 illustrates that the method 500 includes an act 550 of storing a decision attribute within a relationship dataset. Act 550 comprises, responsive to receiving the first relationship indication, storing a first decision attribute within a first decision engine dataset. The first decision attribute indicates that the first decision engine has generated the first relationship indication with respect to the first variable and the second variable. For example, as depicted and described with respect to FIG. 1, the response processing module 150 stores the relationship attribute into a decision engine dataset 114.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RANI and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for managing a multi-input adaptive decision making engine, comprising:
one or more processors; and
one or more computer-readable media having stored thereon executable instructions that when executed by the one or more processors configure the computer system to perform at least the following:
generate a first query object that requests a first relationship indication indicating a relationship between a first variable and a second variable, wherein the first variable and the second variable are presented with the first query object;
receive from a first decision engine, the first relationship indication that characterizes the relationship between the first variable and the second variable;
responsive to receiving the first relationship indication:
store a first relationship attribute within a first variable dataset, wherein the first relationship attribute is based upon the first relationship indication,
store the first relationship attribute within a second variable dataset, wherein the first relationship attribute is based upon the first decision input, and
store a first decision attribute within a first decision engine dataset, wherein the first decision attribute indicates that the first decision engine has generated the first relationship indication with respect to the first variable and the second variable.

2. The computer system as recited in claim 1, wherein the executable instructions include instructions that are executable to configure the computer system to:
receive from a second decision engine, a second relationship indication that characterizes the relationship between the first variable and the second variable;
responsive to receiving the second relationship indication:
store a second relationship attribute within the first variable dataset, wherein the second relationship attribute is based upon the second relationship indication,
store the second relationship attribute within the second variable dataset, wherein the second relationship attribute is based upon the second decision input, and
store a second decision attribute within the first decision engine dataset, wherein the second decision attribute indicates that the second decision engine has generated the second relationship indication with respect to the first variable and the second variable,
wherein the first decision engine is different than the second decision engine.

3. The computer system as recited in claim 2, wherein the first decision engine comprises user input received from a first user.

4. The computer system as recited in claim 3, wherein the second decision engine comprises user input received from a second user.

5. The computer system as recited in claim 3, wherein the second decision engine comprises input from a neural network.

6. The computer system as recited in claim 2, wherein the executable instructions include instructions that are executable to configure the computer system to:
generate a consensus relationship indication indicating the relationship between the first variable and the second variable, wherein the consensus relationship indication is calculated based upon a weighted summation of relationship attributes received from multiple different decision engines.

7. The computer system as recited in claim 6, wherein the executable instructions include instructions that are executable to configure the computer system to:
determine that the first relationship indication aligns with the consensus relationship indication; and
increase a first weighting associated with the first decision engine.

8. The computer system as recited in claim 7, wherein the executable instructions include instructions that are executable to configure the computer system to:
determine that the second relationship indication does not align with the consensus relationship indication; and
decrease a second weighting associated with the second decision engine.

9. The computer system as recited in claim 1, wherein the first query object comprises a first user profile and the second query object comprises a second user profile.

10. The computer system as recited in claim 9, wherein the first relationship indication comprises an indication of a good relationship match between the first user profile and the second user profile.

11. A computer implemented method for managing a multi-input adaptive decision making engine, comprising:
generating a first query object that requests a first relationship indication indicating a relationship between a first variable and a second variable, wherein the first variable and the second variable are presented with the first query object;
receiving from a first decision engine, the first relationship indication that characterizes the relationship between the first variable and the second variable;
responsive to receiving the first relationship indication:
storing a first relationship attribute within a first variable dataset, wherein the first relationship attribute is based upon the first relationship indication,
storing the first relationship attribute within a second variable dataset, wherein the first relationship attribute is based upon the first decision input, and
storing a first decision attribute within a first decision engine dataset, wherein the first decision attribute indicates that the first decision engine has generated the first relationship indication with respect to the first variable and the second variable.

12. The method as recited in claim 11, further comprising:
receiving from a second decision engine, a second relationship indication that characterizes the relationship between the first variable and the second variable;
responsive to receiving the second relationship indication:
storing a second relationship attribute within the first variable dataset, wherein the second relationship attribute is based upon the second relationship indication,
storing the second relationship attribute within the second variable dataset, wherein the second relationship attribute is based upon the second decision input, and
storing a second decision attribute within the first decision engine dataset, wherein the second decision attribute indicates that the second decision engine has generated the second relationship indication with respect to the first variable and the second variable,
wherein the first decision engine is different than the second decision engine.

13. The method as recited in claim 12, wherein the first decision engine comprises user input received from a first user.

14. The method as recited in claim 13, wherein the second decision engine comprises user input received from a second user.

15. The method as recited in claim 13, wherein the second decision engine comprises input from a neural network.

16. The method as recited in claim 12, wherein the executable instructions include instructions that are executable to configure the computer system to:
generate a consensus relationship indication indicating the relationship between the first variable and the second variable, wherein the consensus relationship indication is calculated based upon a weighted summation of relationship attributes received from multiple different decision engines.

17. The method as recited in claim 16, wherein the executable instructions include instructions that are executable to configure the computer system to:
determine that the first relationship indication aligns with the consensus relationship indication; and
increase a first weighting associated with the first decision engine.

18. The method as recited in claim 11, wherein the first query object comprises a first user profile and the second query object comprises a second user profile.

19. The method as recited in claim 18, wherein the first relationship indication comprises an indication of a good relationship match between the first user profile and the second user profile.

20. A method for managing a multi-input adaptive decision making engine, comprising:
selecting a first profile associated with a first user from a first dataset,
selecting a second profile associated with a second user from a second dataset;
generating a first query object that requests a decision input relating to a relationship between data within the first profile and data within the second profile;
generating a user interface object that includes the first query object;
identifying multiple profiles associated with multiple users from a third dataset;
displaying the user interface object to the multiple users;
receiving relationship indications from the multiple users, wherein the relationship indications characterizes a relationship between the first user and the second user; and
displaying to the first user a visual indication that corresponds to the relationship indications from the multiple users.
